(19) United States
(12) Patent Application Publication
(10) Pub. No.: US 2021/0044996 A1
(43) Pub. Date: Feb. 11, 2021

(54) Methods and Devices for Status Exposure in Wireless Communication Networks

(71) Applicant: Telefonaktiebolaget LM Ericsson (publ), Stockholm (SE)

(72) Inventor: Hongxia Long, Shanghai (CN)

(21) Appl. No.: 16/964,312

(22) PCT Filed: Jan. 29, 2019
(86) PCT No.: PCT/CN2019/073626

§ 371 Date: Jul. 23, 2020

(30) Foreign Application Priority Data
Jan. 31, 2018 (CN) PCT/CN2018/074668

(51) Int. Cl. H04W 24/10; H04W 24/08; H04W 76/15

(52) U.S. Cl. CPC H04W 24/10; H04W 76/15; H04W 24/08

(57) ABSTRACT

A method implemented by a first network node in a wireless communication network is provided. The method may comprise: locating a second network node in the wireless communication network; transmitting a configuration request for monitoring one or more events comprising secondary radio access technology, RAT, usage to the second network node; and receiving a report on a secondary RAT usage event from the second network node. The dual connectivity usage of both the primary RAT and the secondary RAT can be monitored for a single UE. Therefore, the services or applications requiring the secondary RAT usage status are able to process specific business logics.

### TECHNICAL FIELD

The present disclosure generally relates to wireless communication networks, and more specifically to methods and devices for status exposure in wireless communication networks.

### BACKGROUND

This section introduces aspects that may facilitate better understanding of the present disclosure. Accordingly, the statements of this section are to be read in this light and are not to be understood as admissions about what is in the prior art or what is not in the prior art.

The E-UTRAN (Evolved UMTS (Universal Mobile Telecommunications System) Terrestrial Radio Access Network) consists of a plurality of eNBs, providing E-UTRA (Evolved UMTS Terrestrial Radio Access) user plane and control plane protocol terminations towards a user equipment (UE). The eNBs are interconnected with each other by means of X2 interfaces, and connected to the Evolved Packet Core (EPC) by means of S1 interfaces, more specifically to the Mobility Management Entity (MME) by means of S1-MME interfaces and to the Serving Gateway (S-GW) by means of S1-U interfaces. The S1 interfaces support many-to-many relations between the MMEs/S-GWs and the eNBs.

The E-UTRAN supports a Dual Connectivity (DC) operation in which a multiple Rx/Tx UE in a RRC CONNECTED state may be configured to utilize radio resources provided by two distinct schedulers located in two eNBs connected via a non-ideal backhaul over the X2 interface. The overall E-UTRAN architecture may also be applicable to the DC. eNBs involved in the DC for a certain UE may assume two different roles: an eNB may either act as a Master eNB (MeNB) or as a Secondary eNB (SeNB). In the DC operation, a UE may be connected to one MeNB and one SeNB.

Multi-Radio Access Technology (Multi-RAT) Dual Connectivity (MR-DC) is a generalization of the Intra-E-UTRA Dual Connectivity (DC), in which a multiple Rx/Tx UE may be configured to utilize radio resources provided by two distinct schedulers in two different nodes connected via a non-ideal backhaul, one providing E-UTRA access and the other providing New Radio (NR) access. One of the schedulers is located in the Master Node (MN) and the other is located in the Secondary Node (SN). The MN and SN are connected via a network interface and at least the MN is connected to the core network.

FIG. 1A is a schematic diagram illustrating control plane connectivity for E-UTRA-NR Dual Connectivity (EN-DC). FIG. 1B is a schematic diagram illustrating control plane connectivity for Multi-RAT Dual Connectivity (MR-DC) with 5G Core (5GC). FIG. 1C is a schematic diagram illustrating user plane connectivity for the EN-DC. FIG. 1D is a schematic diagram illustrating user plane connectivity for the MR-DC with the 5GC.

As shown in FIG. 1A, the E-UTRAN supports the MR-DC via the EN-DC, in which a UE may be connected to an eNB that acts as an MN and an en-gNB that acts as an SN. The eNB is connected to the EPC and the en-gNB is connected to the eNB via the X2 interface.

With regard to the MR-DC with the 5GC, as shown in FIG. 1B, the MME is replaced by the Access and Mobility Management Function (AMF); and as shown in FIG. 1D, the S-GW is replaced by the User Plane Function (UPF). In the MR-DC with the 5GC, as to E-UTRA-NR Dual Connectivity, the Next Generation Radio Access Network (NG-RAN) supports NG-RAN E-UTRA-NR Dual Connectivity (NGEN-DC), in which a UE may be connected to an ng-eNB that acts as an MN and a gNB that acts as an SN. The ng-eNB is connected to the 5GC and the gNB is connected to the ng-eNB via the Xn interface. Moreover, as to NR-E-UTRA Dual Connectivity in the MR-DC with the 5GC, the NG-RAN supports NR-E-UTRA Dual Connectivity (NE-DC), in which a UE may be connected to a gNB that acts as an MN and an ng-eNB that acts as an SN. The gNB is connected to the 5GC and the ng-eNB is connected to the gNB via the Xn interface.

FIG. 2 is a schematic diagram illustrating a 4G peer to peer based architecture of a Service Capability Exposure Function (SCEF), which provides a way to securely expose and discover services and capabilities provided by 3GPP (3rd Generation Partner Project) network interfaces. As shown in FIG. 2, the SCEF may provide access to network capabilities through homogenous network application programming interfaces (APIs) defined over the T8 interfaces for the Service Capability Servers (SCSs)/Application Servers (ASs), and may abstract the services from the underlying 3GPP network interfaces and protocols, e.g., via various interfaces towards entities such as the Home Subscriber Server (HSS), the Policy and Charging Rules Function (PCRF), the Packet Flow Description Function (PFDF), the MME/SGSN (Serving GPRS (General Packet Radio Service) Support Node), the Broadcast Multicast Service Center (BM-SC), the Serving Call Session Control Function (S-CSCF), the RAN Congestion Awareness Function (RCAF), etc. Individual instances of the SCEF may vary depending on what service capabilities are exposed and what API features are supported.

The SCEF is always located in the trust domain. However, the SCS/AS may either belong to the trust domain, or may be located outside the trust domain.

The functionality of the SCEF may include:
Authentication and Authorization:
   Identification of the API consumer,
   Profile management, and
   ACL (Access Control List) management;
Ability for external entities to discover the exposed service capabilities;
Policy enforcement:
   Infrastructural Policy: policies to protect platforms and networks, an example of which may be ensuring that a service node such as SMS-SC (Short Message Service—Service Center) is not overloaded,
   Business Policy: policies related to the specific functionality exposed, an example of which may be number portability, service routing, subscriber consent, etc., and
   Application Layer Policy: policies that are primarily focused on message payload or throughput provided by an application, an example of which may be throttling;
Assurance:
   Integration with O&M (Operation & Maintenance) systems, and
   Assurance process related to usage of APIs;
Accounting for inter-operator settlements;
Access: issues related to external interconnection and point of contact; and
Abstraction: hiding the underlying 3GPP network interfaces and protocols to allow full network integration, supporting functions of:
   Underlying protocol connectivity, routing and traffic control,
   Mapping specific APIs onto appropriate network interfaces, and
   Protocol translation.

The SCEF should protect other PLMN (Public Land Mobile Network) entities (e.g., HSS, MME, etc.) from requests exceeding a permission arranged in the Service-Level Agreement (SLA) with a third-party service provider. The SCEF may support mapping between information exchanged with the SCS/AS (e.g., geographical identifiers) and information exchanged with internal PLMN functions (e.g., cell-ID, eNB-ID, TAI (Tracking Area Identity), MBMS SAI (Multimedia Broadcast Multicast Service—Service Area Identity), etc.). The mapping may be provided by the SCEF based on local configuration data.

FIG. 3 is a schematic diagram illustrating a 5G service based architecture of a Network Exposure Function (NEF), which supports external exposure of capabilities of network functions. As shown in FIG. 3, the NEF is connected via an Nnef interface to a communication line, which is connected to network entities such as the Network Exposure Function (NEF), the Network Slice Selection Function (NSSF), the Network Repository Function (NRF), the Policy Control Function (PCF), the Unified Data Management (UDM), the Application Function (AF), the Authentication Server Function (AUSF), the Access and Mobility Management Function (AMF), the Session Management Function (SMF), etc. via various interfaces. The AMF and the SMF together function in a similar way to the MME, Serving Gateway Control Plane (S-GW-CP) and Packet Data Network (PDN) Gateway Control Plane (P-GW-CP) in a 4G system. As also shown in FIG. 3, the AMF communicates with the UE via an N1 interface and with the (Radio) Access Network ((R)AN) via an N2 interface, and the SMF communicates via an N4 interface with the User Plane Function (UPF), which communicates with the (R)AN via an N3 interface and with the Data Network (DN) via an N6 interface.

The external exposure may be categorized as a monitoring capability, a provisioning capability and a policy/charging capability. The monitoring capability is to monitor specific events for a UE in a 5G system and to make such monitoring events information available for the external exposure via the NEF. The provisioning capability is to allow an external party to provision information which can be used for the UE in the 5G system. The policy/charging capability is to handle a Quality of Service (QoS) and charging policy for the UE based on a request from the external party.

Specifically, the monitoring capability may comprise means that allow identification of 5G network functions suitable for configuring the specific monitoring events, detecting the monitoring events, and reporting the monitoring events to the authorized external party. The monitoring capability may be used to expose a mobility management context of the UE, such as a UE location, reachability, a roaming status, and a loss of connectivity, etc.

The provisioning capability may comprise means that allow identification of 5G network functions responsible for adopting provisioning information from the external party, receiving the provisioning information, and using the provisioning information for the UE. The provisioning capability may be used for mobility management and session management of the UE. For the mobility management of the UE, a mobility pattern may be provisioned. For the session management of the UE, a communication pattern may be provisioned, such as periodic communication time, communication duration time, and scheduled communication time.

The policy/charging capability may comprise means that allow for a request for a session and charging policy, enforce a QoS policy, and apply accounting functionality. The policy/charging capability may be used for specific QoS/priority handling of a session of the UE, and for setting an applicable charging party or charging rate.

In general, the service capability exposure in both the current 4G peer to peer and 5G service based systems is only performed for master connectivity, but not related to whether there is dual connectivity. Even if the service is a dual connectivity related service, capability exposure for the secondary RAT, especially on a usage status, is not exposed yet.

More specifically, in HSS product development to support a 5G non-standalone architecture, 4G subscribers are provisioned with a feature of “NR as secondary RAT” to boost the data plane only. In a commercial sense, active users are also calculated to charge operators on capacity license fees. However, since there is no indication of secondary RAT usage for prior art interfaces between the MME and the HSS, the secondary RAT usage in the EN-DC dual connectivity is entirely transparent to core network nodes. It is not possible to calculate the active 4G subscribers, who are really using the NR as the secondary RAT, with the feature of “NR as secondary RAT”.

Furthermore, the secondary RAT usage may be required from external or internal services. However, existing solutions are only targeted for the master connectivity.

### SUMMARY

It is an object of the present disclosure to configure monitoring events for a secondary RAT usage status and to report events for the secondary RAT usage status, e.g., start, modification and stop event reporting of the secondary RAT usage.

Therefore, when the secondary RAT usage status is needed, it may be monitored by network nodes. When the secondary RAT usage event is triggered, the secondary RAT usage status may be reported and consumed by a consumer. Then, the consumer may execute a corresponding business logic based on the received secondary RAT usage events.

According to a first aspect of the present disclosure, a method implemented by a first network node in a wireless communication network is provided. The method may comprise: locating a second network node in the wireless communication network; transmitting a configuration request for monitoring one or more events comprising secondary radio access technology, RAT, usage to the second network node; and receiving a report on a secondary RAT usage event from the second network node.

In an alternative embodiment of the first aspect, the secondary RAT usage event may include a secondary RAT usage start event.

In a further alternative embodiment of the first aspect, if secondary RAT connectivity is modified and/or released, the secondary RAT usage event may further include a secondary RAT usage modification event and/or a secondary RAT usage stop event.

According to a second aspect of the present disclosure, a method implemented by a second network node in a wireless communication network is provided. The method may comprise: receiving a configuration request for monitoring one or more events comprising secondary radio access technology, RAT, usage from a previous network node; transmitting the configuration request to a subsequent network node located by the second network node; receiving a report on a secondary RAT usage event from the subsequent network node; and transmitting the report to the previous network node.

According to a third aspect of the present disclosure, a method implemented by a third network node in a wireless communication network is provided. The method may comprise: receiving a configuration request for monitoring one or more events comprising secondary radio access technology, RAT, usage from a previous network node; transmitting the configuration request to a fifth network node; receiving a report on a secondary RAT usage event from the fifth network node; and transmitting the report to the previous network node.

According to a fourth aspect of the present disclosure, a method implemented by a fourth network node in a wireless communication network is provided. The method may comprise: transmitting a configuration request for monitoring one or more events comprising secondary radio access technology, RAT, usage to a subsequent network node; and receiving a report on a secondary RAT usage event from the subsequent network node.

According to a fifth aspect of the present disclosure, a method implemented by a fifth network node in a wireless communication network is provided. The method may comprise: receiving a configuration request for monitoring one or more events comprising secondary radio access technology, RAT, usage from a third network node; and after secondary RAT connectivity is established/modified/released, transmitting a report on a secondary RAT usage event to the third network node.

According to a sixth aspect of the present disclosure, a first network node in a wireless communication network is provided. The first network node may comprise a processor and a memory communicatively coupled to the processor. The memory may be adapted to store instructions which, when executed by the processor, may cause the first network node to perform operations of the method according to the above first aspect.

According to a seventh aspect of the present disclosure, a second network node in a wireless communication network is provided. The second network node may comprise a processor and a memory communicatively coupled to the processor. The memory may be adapted to store instructions which, when executed by the processor, may cause the second network node to perform operations of the method according to the above second aspect.

According to an eighth aspect of the present disclosure, a third network node in a wireless communication network is provided. The third network node may comprise a processor and a memory communicatively coupled to the processor. The memory may be adapted to store instructions which, when executed by the processor, may cause the third network node to perform operations of the method according to the above third aspect.

According to a ninth aspect of the present disclosure, a fourth network node in a wireless communication network is provided. The fourth network node may comprise a processor and a memory communicatively coupled to the processor. The memory may be adapted to store instructions which, when executed by the processor, may cause the fourth network node to perform operations of the method according to the above fourth aspect.

According to a tenth aspect of the present disclosure, a fifth network node in a wireless communication network is provided. The fifth network node may comprise a processor and a memory communicatively coupled to the processor. The memory may be adapted to store instructions which, when executed by the processor, may cause the fifth network node to perform operations of the method according to the above fifth aspect.

According to an eleventh aspect of the present disclosure, a wireless communication system is provided. The wireless communication system may comprise: a first network node according to the above sixth aspect; a second network node according to the above seventh aspect communicating with at least the first network node; a third network node according the above eighth aspect communicating with at least the second network node; a fourth network node according to the above ninth aspect communicating with at least the second network node and the third network node; and a fifth network node according to the above tenth aspect communicating with at least the third network node.

According to a twelfth aspect of the present disclosure, a non-transitory computer readable medium having a computer program stored thereon is provided. When the computer program is executed by a set of one or more processors of the first network node, the computer program may cause the first network node to perform operations of the method according to the above first aspect.

According to a thirteenth aspect of the present disclosure, a non-transitory computer readable medium having a computer program stored thereon is provided. When the computer program is executed by a set of one or more processors of the second network node, the computer program may cause the second network node to perform operations of the method according to the above second aspect.

According to a fourteenth aspect of the present disclosure, a non-transitory computer readable medium having a computer program stored thereon is provided. When the computer program is executed by a set of one or more processors of the third network node, the computer program may cause the third network node to perform operations of the method according to the above third aspect.

According to a fifteenth aspect of the present disclosure, a non-transitory computer readable medium having a computer program stored thereon is provided. When the computer program is executed by a set of one or more processors of the fourth network node, the computer program may cause the fourth network node to perform operations of the method according to the above fourth aspect.

According to a sixteenth aspect of the present disclosure, a non-transitory computer readable medium having a computer program stored thereon is provided. When the computer program is executed by a set of one or more processors of the fifth network node, the computer program may cause the fifth network node to perform operations of the method according to the above fifth aspect.

In the present disclosure, the dual connectivity usage of both the primary RAT and the secondary RAT can be monitored for a single UE. Therefore, the services or applications requiring the secondary RAT usage status are able to process specific business logics. For example, the HSS/UDM may be enabled to precisely calculate the active users.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1A is a schematic diagram illustrating control plane connectivity for the EN-DC;

FIG. 1B is a schematic diagram illustrating control plane connectivity for the MR-DC with the 5GC;

FIG. 1C is a schematic diagram illustrating user plane connectivity for the EN-DC;

FIG. 1D is a schematic diagram illustrating user plane connectivity for the MR-DC with the 5GC;

FIG. 2 is a schematic diagram illustrating a 4G peer to peer based architecture of an SCEF;

FIG. 3 is a schematic diagram illustrating a 5G service based architecture of an NEF;

FIG. 4 is an exemplary sequence diagram illustrating processes for monitoring and reporting the secondary RAT events according to some embodiments of the present disclosure;

FIG. 5 is a flow chart illustrating a method implemented on a first network node according to some embodiments of the present disclosure;

FIG. 6 is a flow chart illustrating a method implemented on a second network node according to some embodiments of the present disclosure;

FIG. 7 is a flow chart illustrating a method implemented on a third network node according to some embodiments of the present disclosure;

FIG. 8 is a flow chart illustrating a method implemented on a fourth network node according to some embodiments of the present disclosure;

FIG. 9 is a flow chart illustrating a method implemented on a fifth network node according to some embodiments of the present disclosure;

FIG. 10 is a block diagram illustrating a first network node according to some embodiments of the present disclosure;

FIG. 11 is another block diagram illustrating a first network node according to some embodiments of the present disclosure;

FIG. 12 is a block diagram illustrating a second network node according to some embodiments of the present disclosure;

FIG. 13 is another block diagram illustrating a second network node according to some embodiments of the present disclosure;

FIG. 14 is a block diagram illustrating a third network node according to some embodiments of the present disclosure;

FIG. 15 is another block diagram illustrating a third network node according to some embodiments of the present disclosure;

FIG. 16 is a block diagram illustrating a fourth network node according to some embodiments of the present disclosure;

FIG. 17 is another block diagram illustrating a fourth network node according to some embodiments of the present disclosure;

FIG. 18 is a block diagram illustrating a fifth network node according to some embodiments of the present disclosure;

FIG. 19 is another block diagram illustrating a fifth network node according to some embodiments of the present disclosure;

FIG. 20 is a block diagram illustrating a wireless communication system according to some embodiments of the present disclosure.

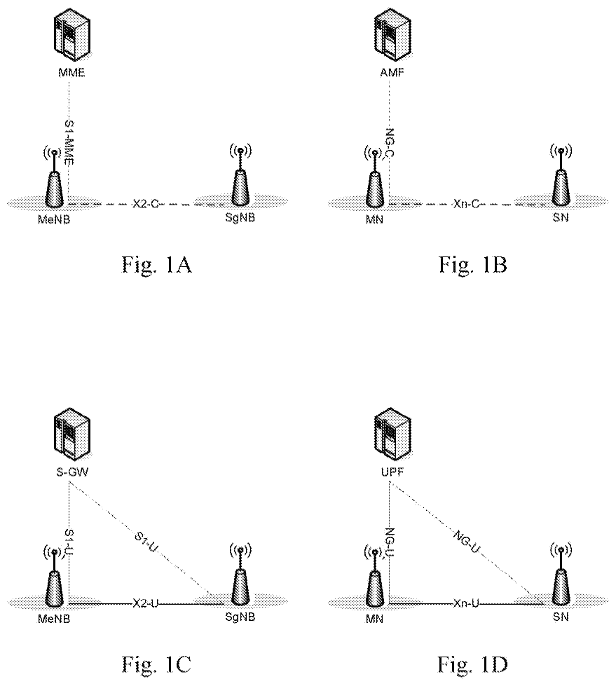

### DETAILED DESCRIPTION

The following detailed description describes methods and devices for status exposure. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

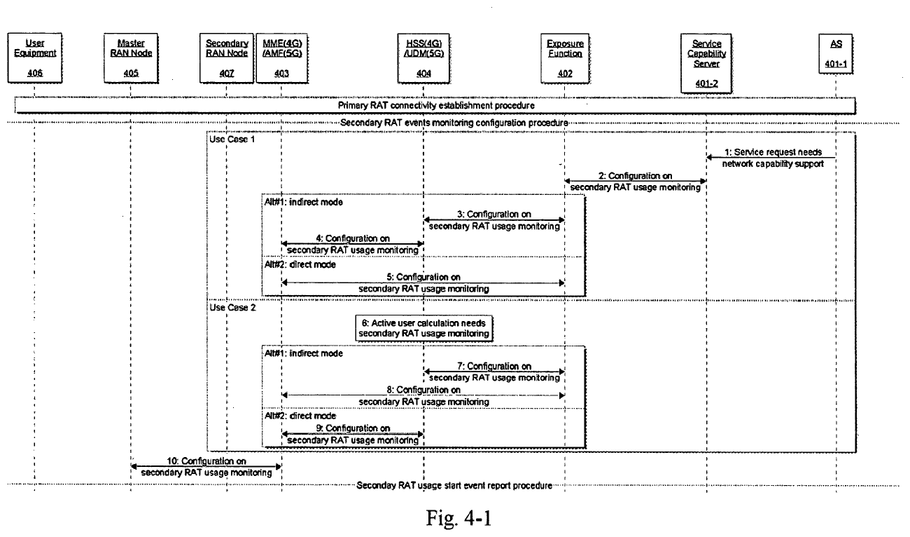

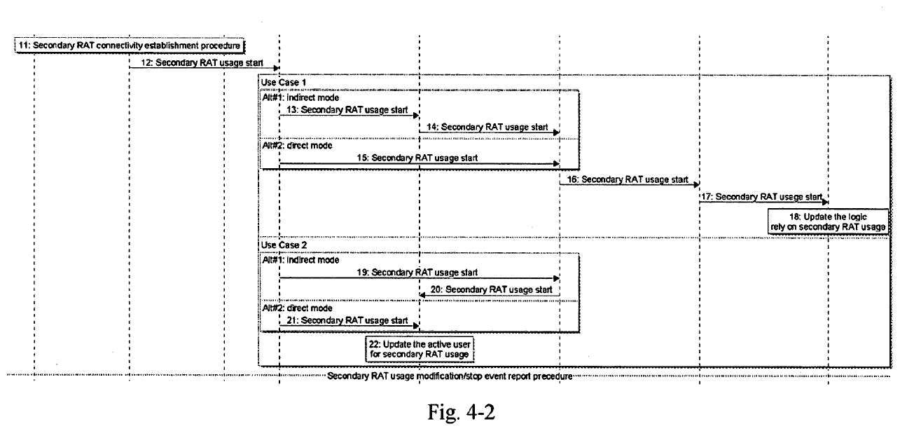

FIG. 4 is an exemplary sequence diagram illustrating processes for monitoring and reporting the secondary RAT events according to some embodiments of the present disclosure. A communication system for the secondary RAT event monitoring and reporting is shown in FIG. 4, comprising at least an AS 401-1, an SCS 401-2, an exposure function (EF) 402, an MME/AMF 403, an HSS/UDM 404, a master RAN node 405, a UE 406 and a secondary RAN node 407. Two use cases are built in FIG. 4 and named Use Case 1 and Use Case 2.

In an example, a combination of the SCS 401-2 with the AS 401-1 may be replaced with an Application Function (AF) in the 5G service based architecture. The AF is not shown in FIG. 4 for simplicity.

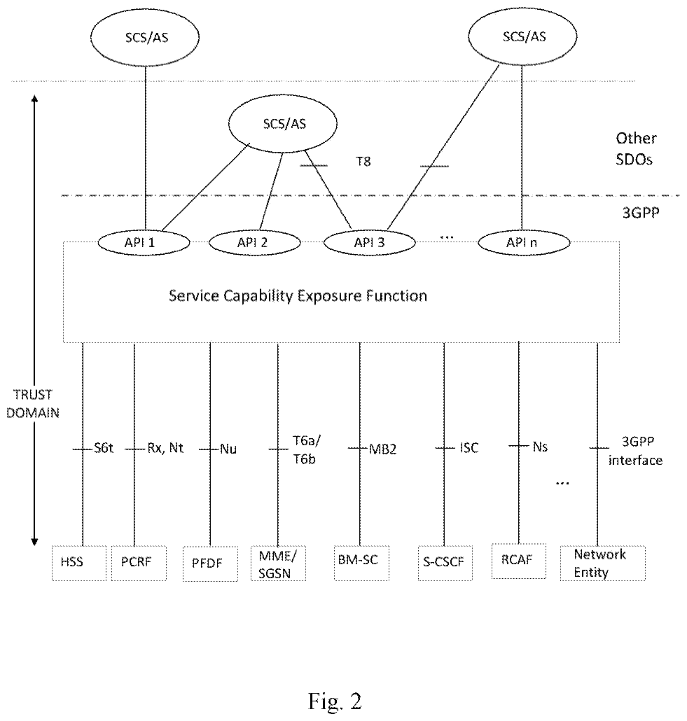

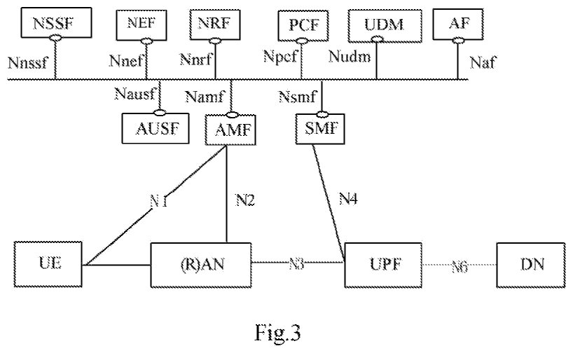

In the Use Case 1, the AS 401-1, which has a certain business logic depending on the secondary RAT usage status, is located outside the trusted domain, so it may request information from the SCS 401-2 which may further request the information from EF 402. The EF 402 may represent an SCEF function entity in the 4G peer to peer based architecture as shown in FIG. 2 or an NEF function entity in the 5G service based architecture as shown in FIG. 3.

The business logic may be application specific. Some examples of the business logic may include without limitation:

differentiated charging, i.e. the usage of master connectivity and secondary connectivity charged with different ratings;

active user statistics, i.e. calculating users who are on the master connectivity and secondary connectivity correspondingly, so as to plan network capacity accordingly based on traffic status; and

traffic influence: if the master connectivity is loaded and the secondary connectivity is low, then for a new service flow of this application, the network may be influenced to setup new service flow traffic on the secondary connectivity.

In the Use Case 2, a network function (NF) 404 (e.g., the HSS in the 4G peer to peer based architecture or the UDM in the 5G service based architecture), which is located inside the trusted domain, may request information from other nodes in either of an indirect mode and a direct mode. In the indirect mode, the HSS/UDM 404 may access the EF 402 so as to indirectly obtain exposed information on the secondary RAT usage from another network node, such as the MME/AMF 403. In the direct mode, the HSS/UDM 404 may directly access the network node to obtain the information on the secondary RAT usage.

More specifically, as shown in FIG. 4, after primary RAT connectivity is established between the UE 406 and the Master RAN node 405, secondary RAT event monitoring is configured.

In the Use Case 1, at step 1, the AS 401-1, which has the certain business logic depending on the secondary RAT usage status, may request input information from the SCS 401-2, including an external identity for identifying the UE 406 connected to the secondary RAT. As an example, the external identity may be either about a single UE (Generic Public Subscription Identifier (GPSI)) or a group of UEs (GroupId) or any UE (anyUE), etc.

At step 2, the SCS 401-2 may identify that a capability requested in the input information is from a 3GPP network, locate an EF 402 for that network based on the external identity, and request the required information from the EF 402.

Then, the EF 402 may identify network nodes which are responsible for reporting the requested information, and determine how to send the configuration request on secondary RAT usage events. This may be performed also in an indirect mode or in a direct mode. In the indirect mode, at step 3, the EF 402 may forward the request to a located HSS/UDM 404, which may in turn forward the request to a located MME(4G)/AMF(5G) 403 at step 4. In the direct mode, at step 5, the EF 402 may forward the request directly to the identified MME/AMF 403. In this process, authentication and authorization may be enforced for security reasons, and the identity for which events need to be monitored should be translated into an internal identity (e.g., either a single UE (Subscription Permanent Identifier (SUPI), Generic Public Subscription Identifier (GPSI), Permanent Equipment Identifier (PEI) etc.) or a group of UEs (GroupId) or any UE (anyUE), etc.). As an example, the requested information may include what, when and how to report, e.g., to report the secondary RAT start, modification or stop events in response to triggering, in response to update or periodically based on timer expiry.

In the Use Case 2, at step 6, the NF 404 may has a business logic which may calculate the active user for the secondary RAT usage based on the secondary RAT usage status. The NF 404 may determine whether the indirect mode or the direct mode of the Use Case 2 is to be employed, based on whether event report aggregation is needed. If the event report aggregation is needed, e.g., combined event reports come from both the MME and the PCRF as shown in FIG. 2, then the NF 404 may select the indirect mode to hide complexity. If the event report aggregation is not needed, e.g., only a single event report comes from the MME, then the NF 404 may select the direct mode for better performance.

In the indirect mode of the Use Case 2, at step 7, the NF 404 may locate an EF 402 for the network based on a subscriber identity, which is an internal identity as described above for identifying the UE 406 connected to the secondary RAT. The subscriber identity may represent a single subscriber, a set of subscribers or all types of subscribers supporting multi-RAT dual connectivity. At step 8, the EF 402 may identify network nodes which are responsible for reporting the requested information, and determine how to forward the configuration request on the secondary RAT usage events.

Furthermore, in the direct mode of the Use Case 2, at step 9, the NF 403 may transmit the configuration request directly to the network node 403 which may report the secondary RAT usage events, e.g., the MME/AMF 403.

Then, at step 10, the MME/AMF 403 may further transmit the configuration request to the master RAN node 405 with which the UE 406 has established the primary RAT connectivity.

At step 11, the RAN may decide to add the secondary RAN node 407 at some time so as to establish secondary RAT connectivity between the UE 406 and the secondary RAN node 407. This marks the beginning of a reporting procedure of a secondary RAT usage start event.

At step 12, when the UE 406 has been connected to the secondary RAN node 407, the master RAN node 405 may report the event corresponding to the secondary RAT usage to the MME/AMF 403 based on the received configuration request. In this procedure, the secondary RAT usage start event may be reported.

In the Use Case 1, as to the indirect mode, at step 13, the MME/AMF 403 may forward the secondary RAT usage start event to the HSS/UDM 404, which may in turn transmit it to the EF 402 at step 14; and as to the direct mode, at step 15, the MME/AMF 403 may forward the secondary RAT usage start event to the EF 402. Then, in either mode of the Use Case 1, at step 16, the EF 402 may further forward the secondary RAT usage start event to the SCS 401-2. At step 17, the SCS 401-2 may still further forward the secondary RAT usage start event to the AS 401-1. At step 18, the AS 401-1 may update the business logic associated with the secondary RAT usage status based on the received event.

In the Use Case 2, as to the indirect mode, the MME/AMF 403 may forward the secondary RAT usage start event to the EF 402 at step 19, and the EF 402 may further forward the secondary RAT usage start event to the HSS/UDM 404 at step 20; and as to the direct mode, the MME/AMF 403 may transmit the secondary RAT usage start event directly to the HSS/UDM 404 at step 21. At step 22, the HSS/UDM 404 may update the active user calculation associated with the secondary RAT usage status based on the received event.

At step 23, the secondary RAT connectivity may be modified/released. This is the start of a reporting procedure of a secondary RAT usage modification/stop event. The following steps 24-34 are similar to the above steps 12-22.

At step 24, when the secondary RAT connectivity is modified and/or released, the master RAN node 405 may report the event corresponding to the secondary RAT usage to the MME/AMF 403 based on the received configuration request. In this procedure, the secondary RAT usage modification event and/or the secondary RAT usage stop event may be reported.

In the Use Case 1, as to the indirect mode, at step 25, the MME/AMF 403 may forward the secondary RAT usage modification event and/or the secondary RAT usage stop event to the HSS/UDM 404, which may in turn transmit the event(s) to the EF 402 at step 26; and as to the direct mode, at step 27, the MME/AMF 403 may forward the secondary RAT usage modification event and/or the secondary RAT usage stop event to the EF 402. Then, in either mode of the Use Case 1, at step 28, the EF 402 may further forward the secondary RAT usage modification event and/or the secondary RAT usage stop event to the SCS 401-2. At step 29, the SCS 401-2 may still further forward the secondary RAT usage modification event and/or the secondary RAT usage stop event to the AS 401-1. At step 30, the AS 401-1 may update the business logic associated with the secondary RAT usage status based on the received event.

In the Use Case 2, as to the indirect mode, the MME/AMF 403 may also forward the secondary RAT usage modification event and/or the secondary RAT usage stop event to the EF 402 at step 31, and the EF 402 may further forward the secondary RAT usage modification event and/or the secondary RAT usage stop event to the HSS/UDM 404 at step 32; and as to the direct mode, the MME/AMF 403 may transmit the secondary RAT usage modification event and/or the secondary RAT usage stop event directly to the HSS/UDM 404 at step 33. At step 34, the HSS/UDM 404 may update the active user calculation associated with the secondary RAT usage status based on the received event.

After the procedures of the sequence diagram, the dual connectivity usage of both the primary RAT and the secondary RAT can be monitored for the UE 406. Therefore, the service requiring the secondary RAT usage status, e.g., the AS 401-1, is able to process specific business logics, and the network function associated with the secondary RAT usage status, e.g., the HSS/UDM 404, is able to precisely calculate the active users.

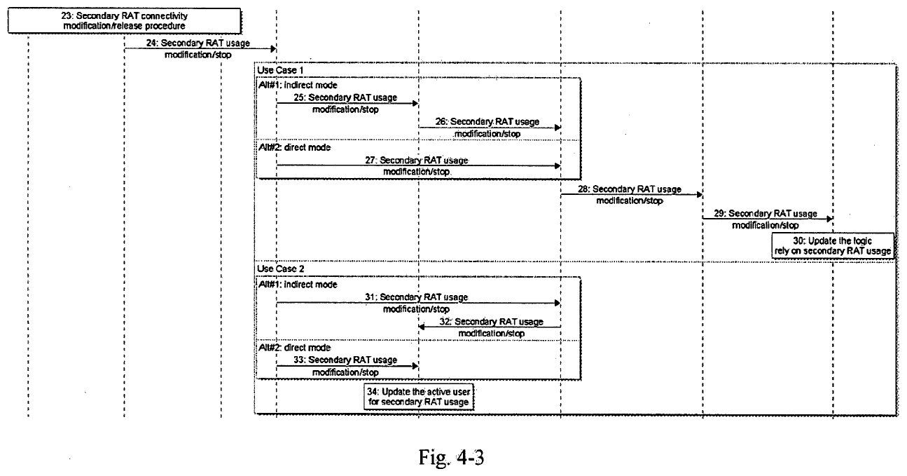

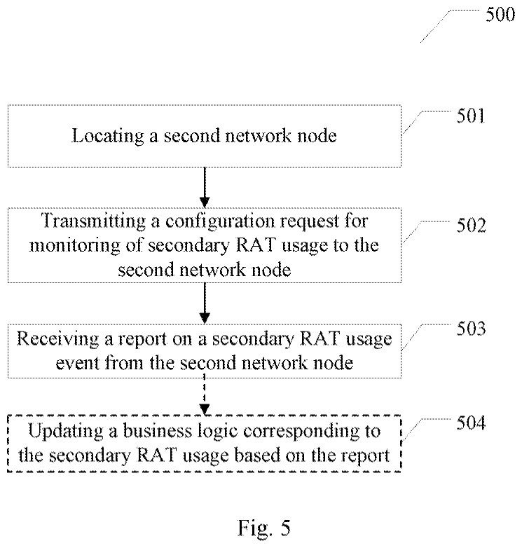

The processes of the sequence diagram will be described in greater detail with respect to the flow charts of FIGS. 5-9 below.

FIG. 5 is a flow chart illustrating a method 500 implemented on a first network node according to some embodiments of the present disclosure. As an example, operations of this flow chart may be performed by a combination of the AS 401-1 and the SCS 401-2 (or the AF) as shown in FIG. 4, or by the EF 402 as shown in FIG. 4, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the method 500 begins with the first network node locating a second network node (block 501). As an example, if the first network node acts as the SCS/AS (or the AF for 5G) as shown in FIG. 4, then the second network node may act as the EF 402 as shown in FIG. 4, which may be the SCEF for 4G or the NEF for 5G. As another example, if the first network node acts as the EF 402, then the second network node may act as the MME/AMF 403 (e.g., in the direct mode of the Use Case 1 or in the indirect mode of the Use Case 2 as shown in FIG. 4) or the HSS/UDM 404 (e.g. in the indirect mode of the Use Case 1 as shown in FIG. 4).

The first network node may then transmit a configuration request for monitoring one or more events comprising secondary RAT usage to the second network node (block 502).

When secondary RAT connectivity has been established/modified/released, the first network node may receive a report on a secondary RAT usage event from the second network node (block 503).

As an example, in the reporting procedure of a secondary RAT usage start event, the secondary RAT usage event may include the secondary RAT usage start event. As a further example, in the subsequent reporting procedure of a secondary RAT usage modification and/or stop event, if the secondary RAT connectivity is modified and/or released, the secondary RAT usage event may further include a secondary RAT usage modification event and/or a secondary RAT usage stop event.

In the case that the first network node acts as the SCS/AS or the AF, the first network node may update a business logic corresponding to the secondary RAT usage based on the received report (block 504). In an example, the configuration request may comprise an external identity for identifying one or more UE connected to the secondary RAT.

Alternatively, in the case that the first network node acts as the EF, the configuration may be received by the first network node from a previous network node (e.g., the SCS/AS or the AF in the Use Case 1, or the HSS/UDM in the Use Case 2) which locates the first network, and may comprise an external identity (e.g., in the Use Case 1) or an internal identity (e.g., in the Use Case 2) for identifying one or more UE connected to the secondary RAT.

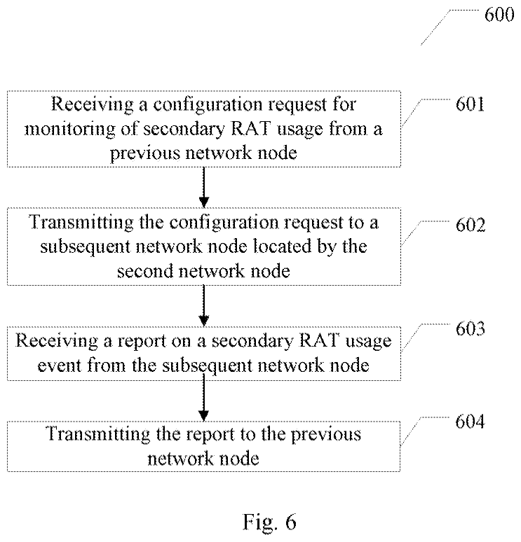

FIG. 6 is a flow chart illustrating a method 600 implemented on a second network node according to some embodiments of the present disclosure. As an example, operations of this flow chart may be performed by an EF 402 as shown in FIG. 4.

In one embodiment, the second network node may receive a configuration request for monitoring one or more events comprising secondary RAT usage from a previous network node (block 601). As an example, in the Use Case 1 in which the configuration request may comprise an external identity, the previous network node may be the SCS 401-2 (or the AF) as shown in FIG. 4, which has located the second network node. As another example, in the indirect mode of the Use Case 2 in which the configuration request may comprise an internal identity, the previous network node may be the HSS/UDM 404 as shown in FIG. 4, which has located the second network node.

In one embodiment, the second network node may transmit the configuration request to a subsequent network node located by the second network node (block 602). As an example, in the Use Case 1, the subsequent network node may be the MME/AMF 403 (e.g., in the direct mode of the Use Case 1) or the HSS/UDM 404 (e.g., in the indirect mode of the Use Case 1) as shown in FIG. 4. As another example, in the indirect mode of the Use Case 2, the subsequent network node may be the MME/AMF 403 as shown in FIG. 4.

When secondary RAT connectivity has been established/modified/released, the second network node may receive a report on a secondary RAT usage event from the subsequent network node (block 603), and further forward the report to the previous network node (block 604).

As an example, in the reporting procedure of a secondary RAT usage start event, the secondary RAT usage event may include the secondary RAT usage start event. As a further example, in the subsequent reporting procedure of a secondary RAT usage modification and/or stop event, if the secondary RAT connectivity is modified and/or released, the secondary RAT usage event may further include a secondary RAT usage modification event and/or a secondary RAT usage stop event.

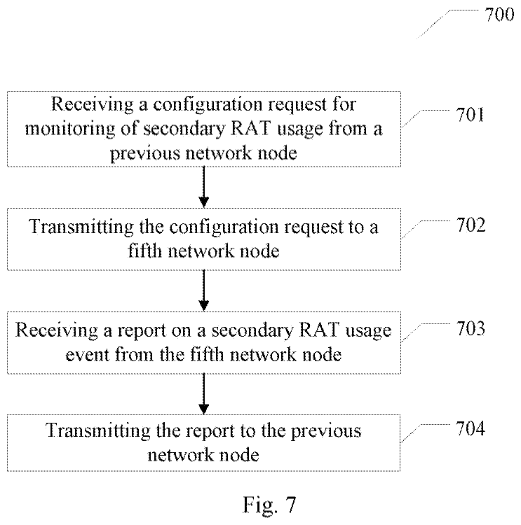

FIG. 7 is a flow chart illustrating a method 700 implemented on a third network node according to some embodiments of the present disclosure. As an example, operations of this flow chart may be performed by the MME/AMF 403 as shown in FIG. 4.

In one embodiment, the third network node may receive a configuration request for monitoring one or more events comprising secondary RAT usage from a previous network node (block 701). As an example, in the Use Case 1 in which the configuration request may comprise an external identity or in the Use Case 2 in which the configuration request may comprise an internal identity, the previous network node may be the EF 402 (e.g., in the direct mode of the Use Case 1 or in the indirect mode of the Use Case 2) or the HSS/UDM 404 (e.g., in the indirect mode of the Use Case 1 or in the direct mode of the Use Case 2) as shown in FIG. 4.

Then, the third network node may transmit the configuration request to a fifth network node (block 702). As an example, the fifth network node may act as the master RAN node 405 as shown in FIG. 4.

When secondary RAT connectivity has been established/modified/released, the third network node may receive a report on a secondary RAT usage event from the fifth network node (block 703), and transmit the report to the previous network node (block 704).

As an example, in the reporting procedure of a secondary RAT usage start event, the secondary RAT usage event may include the secondary RAT usage start event. As a further example, in the subsequent reporting procedure of a secondary RAT usage modification and/or stop event, if the secondary RAT connectivity is modified and/or released, the secondary RAT usage event may further include a secondary RAT usage modification event and/or a secondary RAT usage stop event.

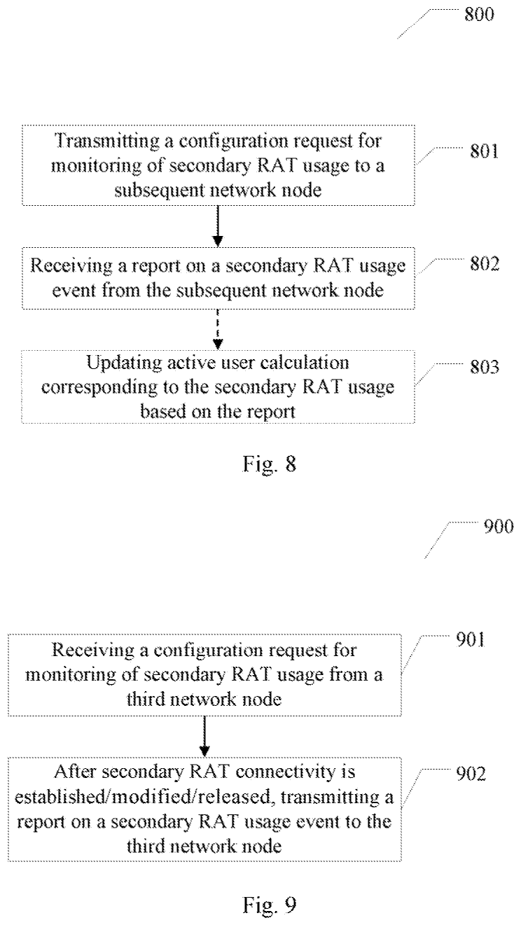

FIG. 8 is a flow chart illustrating a method 800 implemented on a fourth network node according to some embodiments of the present disclosure. As an example, operations of this flow chart may be performed by the HSS/UDM 404 as shown in FIG. 4.

In one embodiment, the fourth network node may transmit a configuration request for monitoring one or more events comprising secondary RAT usage to a subsequent network node (block 801). As an example, in the indirect mode of the Use Case 1 in which the configuration request may comprise an external identity, the configuration request may be received by the fourth network node from the EF 402 as shown in FIG. 4, and the subsequent network node to receive the configuration request may be the MME/AMF 403 as shown in FIG. 4. As another example, in the Use Case 2 in which the configuration request may comprise an internal identity, if the event report aggregation is needed, the fourth network node may select the indirect mode and locate an EF 402 as shown in FIG. 4, so the subsequent network node may be the EF 402 which will forward the configuration request to the MME/AMF 403 as shown in FIG. 4; and if the event report aggregation is not needed, the fourth network node may select the direct mode, so the subsequent network node may directly be the MME/AMF 403 as shown in FIG. 4.

When secondary RAT connectivity has been established/modified/released, the fourth network node may receive a report on a secondary RAT usage event from the subsequent network node (block 802).

In an optional example, in the Use Case 2, the fourth network node may update active user calculation corresponding to the secondary RAT usage based on the received report (block 803).

As an example, in the reporting procedure of a secondary RAT usage start event, the secondary RAT usage event may include the secondary RAT usage start event. As a further example, in the subsequent reporting procedure of a secondary RAT usage modification and/or stop event, if the secondary RAT connectivity is modified and/or released, the secondary RAT usage event may further include a secondary RAT usage modification event and/or a secondary RAT usage stop event.

FIG. 9 is a flow chart illustrating a method 900 implemented on a fifth network node according to some embodiments of the present disclosure. As an example, operations of this flow chart may be performed by the master RAN node 405 as shown in FIG. 4.

In one embodiment, after primary RAT connectivity is established, the fifth network node may receive a configuration request for monitoring one or more events comprising secondary RAT usage from a third network node (block 901). As an example, as described above, the third network node may act as the MME/AMF 403 as shown in FIG. 4.

After secondary RAT connectivity is established/modified/released, the fifth network node may transmit a report on a secondary RAT usage event to the third network node (block 902).

In an example, the configuration request may comprise an external identity in the Use Case 1 or an internal identity in the Use Case 2, as described above.

As an example, in the reporting procedure of a secondary RAT usage start event, the secondary RAT usage event may include the secondary RAT usage start event. As a further example, in the subsequent reporting procedure of a secondary RAT usage modification and/or stop event, if the secondary RAT connectivity is modified and/or released, the secondary RAT usage event may further include a secondary RAT usage modification event and/or a secondary RAT usage stop event.

FIG. 10 is a block diagram illustrating a first network node 1000 according to some embodiments of the present disclosure. As an example, the first network node 1000 may act as a combination of the AS 401-1 and the SCS 401-2 (or the AF) as shown in FIG. 4, or may act as the EF 402 as shown in FIG. 4, but it is not limited thereto. It should be appreciated that the first network node 1000 may be implemented using components other than those illustrated in FIG. 10.

With reference to FIG. 10, the first network node 1000 may comprise at least a processor 1001, a memory 1002, a network interface 1003 and a communication medium 1004. The processor 1001, the memory 1002 and the network interface 1003 may be communicatively coupled to each other via the communication medium 1004.

The processor 1001 may include one or more processing units. A processing unit may be a physical device or article of manufacture comprising one or more integrated circuits that read data and instructions from computer readable media, such as the memory 1002, and selectively execute the instructions. In various embodiments, the processor 1001 may be implemented in various ways. As an example, the processor 1001 may be implemented as one or more processing cores. As another example, the processor 1001 may comprise one or more separate microprocessors. In yet another example, the processor 1001 may comprise an application-specific integrated circuit (ASIC) that provides specific functionality. In still another example, the processor 1001 may provide specific functionality by using an ASIC and/or by executing computer-executable instructions.

The memory 1002 may include one or more computer-usable or computer-readable storage medium capable of storing data and/or computer-executable instructions. It should be appreciated that the storage medium is preferably a non-transitory storage medium.

The network interface 1003 may be a device or article of manufacture that enables the first network node 1000 to send data to or receive data from other network nodes. In different embodiments, the network interface 1003 may be implemented in different ways. As an example, the network interface 1003 may be implemented as an Ethernet interface, a token-ring network interface, a fiber optic network interface, a wireless network interface (e.g., Wi-Fi, WiMax, etc.), or another type of network interface.

The communication medium 1004 may facilitate communication among the processor 1001, the memory 1002 and the network interface 1003. The communication medium 1004 may be implemented in various ways. For example, the communication medium 1004 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 10, the instructions stored in the memory 1002 may include those that, when executed by the processor 1001, cause the first network node to implement the method described with respect to FIG. 5.

FIG. 11 is another block diagram illustrating a first network node 1100 according to some embodiments of the present disclosure. As an example, the first network node 1100 may act as a combination of the AS 401-1 and the SCS 401-2 (or the AF) as shown in FIG. 4, or may act as the EF 402 as shown in FIG. 4, but it is not limited thereto. It should be appreciated that the first network node 1100 may be implemented using components other than those illustrated in FIG. 11.

With reference to FIG. 11, the first network node 1100 may comprise at least a locating unit 1101, a transmission unit 1102 and a receiving unit 1103. The locating unit 1101 may be adapted to perform at least the operation described in the block 501 of FIG. 5. The transmission unit 1102 may be adapted to perform at least the operation described in the block 502 of FIG. 5. The receiving unit 1103 may be adapted to perform at least the operation described in the block 503 of FIG. 5.

As an example, the first network node 1100 may further comprise at least an updating unit 1104. The updating unit 1104 may be adapted to perform at least the operation described in the block 504 of FIG. 5.

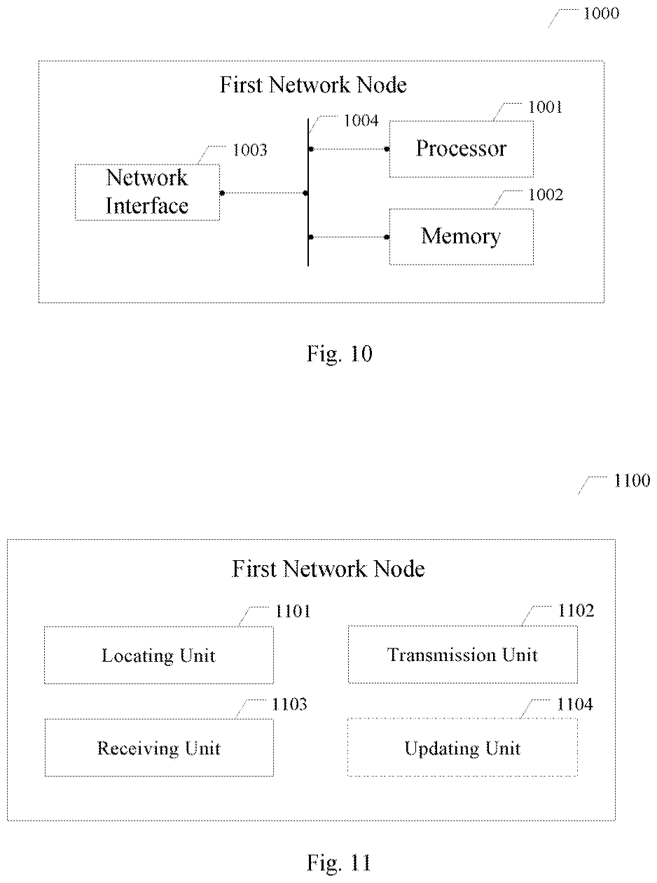

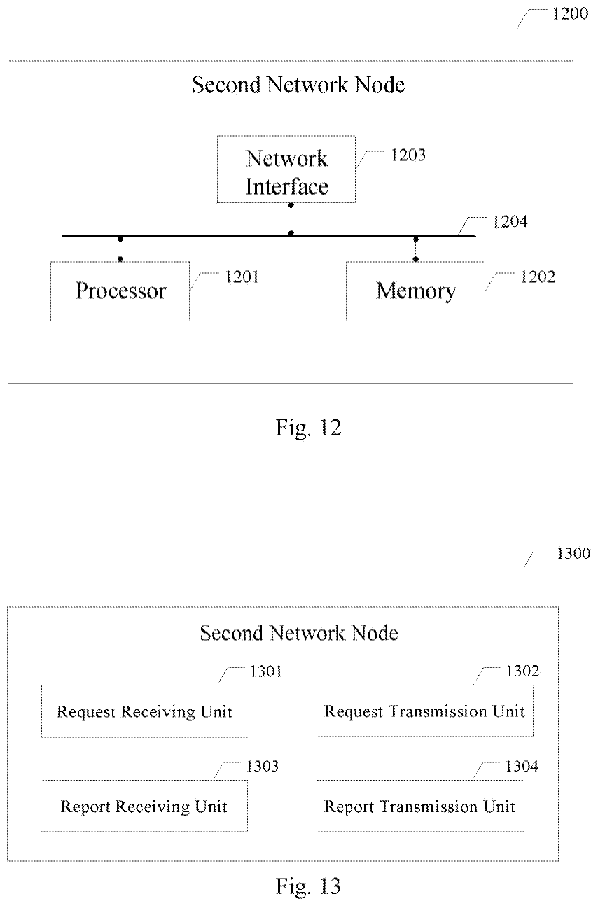

FIG. 12 is a block diagram illustrating a second network node 1200 according to some embodiments of the present disclosure. As an example, the second network node 1200 may act as the EF 402 as shown in FIG. 4. It should be appreciated that the second network node 1200 may be implemented using components other than those illustrated in FIG. 12.

With reference to FIG. 12, the second network node 1200 may comprise at least a processor 1201, a memory 1202, a network interface 1203 and a communication medium 1204. The processor 1201, the memory 1202 and the network interface 1203 are communicatively coupled to each other via the communication medium 1204.

The processor 1201, the memory 1202, the network interface 1203 and the communication medium 1204 are structurally similar to the processor 1001, the memory 1002, the network interface 1003 and the communication medium 1004 respectively, and will not be described herein in detail.

In the example of FIG. 12, the instructions stored in the memory 1202 may include those that, when executed by the processor 1201, cause the second network node 1200 to implement the method described with respect to FIG. 6.

FIG. 13 is another block diagram illustrating a second network node 1300 according to some embodiments of the present disclosure. As an example, the second network node 1300 may act as the EF 402 as shown in FIG. 4. It should be appreciated that the second network node 1300 may be implemented using components other than those illustrated in FIG. 13.

With reference to FIG. 13, the second network node 1300 may comprise at least a request receiving unit 1301, a request transmission unit 1302, a report receiving unit 1303 and a report transmission unit 1304. The request receiving unit 1301 may be adapted to perform at least the operation described in the block 601 of FIG. 6. The request transmission unit 1302 may be adapted to perform at least the operation described in the block 602 of FIG. 6. The report receiving unit 1303 may be adapted to perform at least the operation described in the block 603 of FIG. 6. The report transmission unit 1304 may be adapted to perform at least the operation described in the block 604 of FIG. 6.

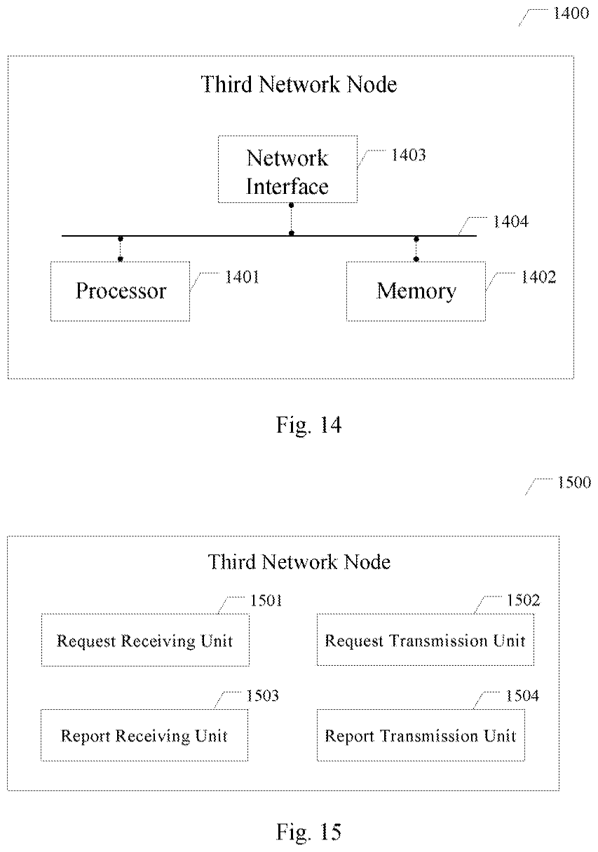

FIG. 14 is a block diagram illustrating a third network node 1400 according to some embodiments of the present disclosure. As an example, the third network node 1400 may act as the MME/AMF 403 as shown in FIG. 4. It should be appreciated that the third network node 1400 may be implemented using components other than those illustrated in FIG. 14.

With reference to FIG. 14, the third network node 1400 may comprise at least a processor 1401, a memory 1402, a network interface 1403 and a communication medium 1404. The processor 1401, the memory 1402 and the network interface 1403 are communicatively coupled to each other via the communication medium 1404.

The processor 1401, the memory 1402, the network interface 1403 and the communication medium 1404 are structurally similar to the processor 1001 or 1201, the memory 1002 or 1202, the network interface 1003 or 1203 and the communication medium 1004 or 1204 respectively, and will not be described herein in detail.

In the example of FIG. 14, the instructions stored in the memory 1402 may include those that, when executed by the processor 1401, cause the third network node 1400 to implement the method described with respect to FIG. 7.

FIG. 15 is another block diagram illustrating a third network node 1500 according to some embodiments of the present disclosure. As an example, the third network node 1500 may act as the MME/AMF 403 as shown in FIG. 4. It should be appreciated that the third network node 1500 may be implemented using components other than those illustrated in FIG. 15.

With reference to FIG. 15, the third network node 1500 may comprise at least a request receiving unit 1501, a request transmission unit 1502, a report receiving unit 1503 and a report transmission unit 1504. The request receiving unit 1501 may be adapted to perform at least the operation described in the block 701 of FIG. 7. The request transmission unit 1502 may be adapted to perform at least the operation described in the block 702 of FIG. 7. The report receiving unit 1503 may be adapted to perform at least the operation described in the block 703 of FIG. 7. The report transmission unit 1504 may be adapted to perform at least the operation described in the block 704 of FIG. 7.

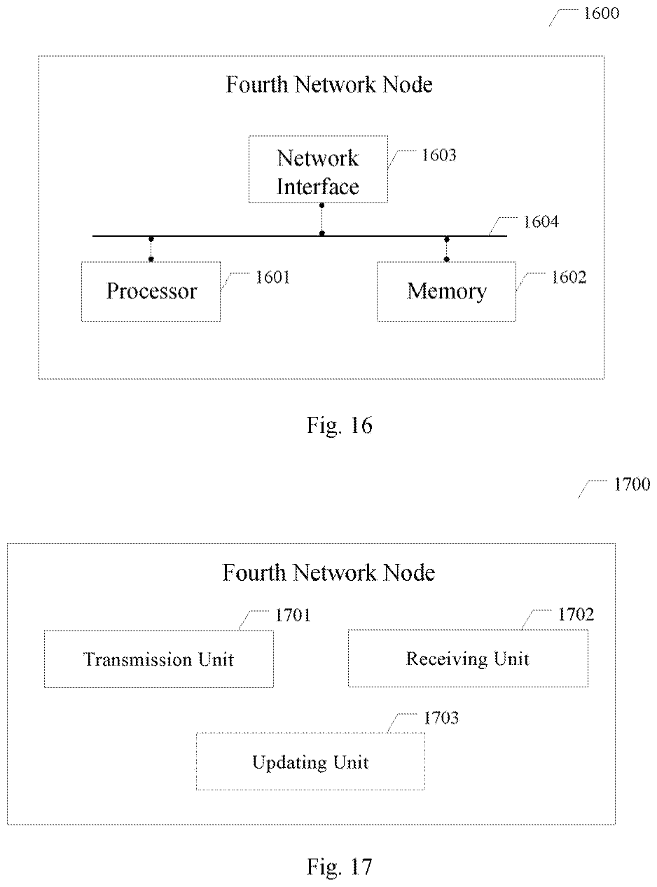

FIG. 16 is a block diagram illustrating a fourth network node 1600 according to some embodiments of the present disclosure. As an example, the fourth network node 1600 may act as the HSS/UDM 404 as shown in FIG. 4. It should be appreciated that the fourth network node 1600 may be implemented using components other than those illustrated in FIG. 16.

With reference to FIG. 16, the fourth network node 1600 may comprise at least a processor 1601, a memory 1602, a network interface 1603 and a communication medium 1604. The processor 1601, the memory 1602 and the network interface 1603 are communicatively coupled to each other via the communication medium 1604.

The processor 1601, the memory 1602, the network interface 1603 and the communication medium 1604 are structurally similar to the processor 1001, 1201 or 1401, the memory 1002, 1202 or 1402, the network interface 1003, 1203 or 1403 and the communication medium 1004, 1204 or 1404 respectively, and will not be described herein in detail.

In the example of FIG. 16, the instructions stored in the memory 1602 may include those that, when executed by the processor 1601, cause the fourth network node 1600 to implement the method described with respect to FIG. 8.

FIG. 17 is another block diagram illustrating a fourth network node 1700 according to some embodiments of the present disclosure. As an example, the fourth network node 1700 may act as the HSS/UDM 404 as shown in FIG. 4. It should be appreciated that the fourth network node 1700 may be implemented using components other than those illustrated in FIG. 17.

With reference to FIG. 17, the fourth network node 1700 may comprise at least transmission unit 1701 and a receiving unit 1702. The transmission unit 1701 may be adapted to perform at least the operation described in the block 801 of FIG. 8. The receiving unit 1702 may be adapted to perform at least the operation described in the block 802 of FIG. 8.

As an example, the fourth network node 1700 may further comprise at least an updating unit 1703. The updating unit 1703 may be adapted to perform at least the operation described in the block 803 of FIG. 8.

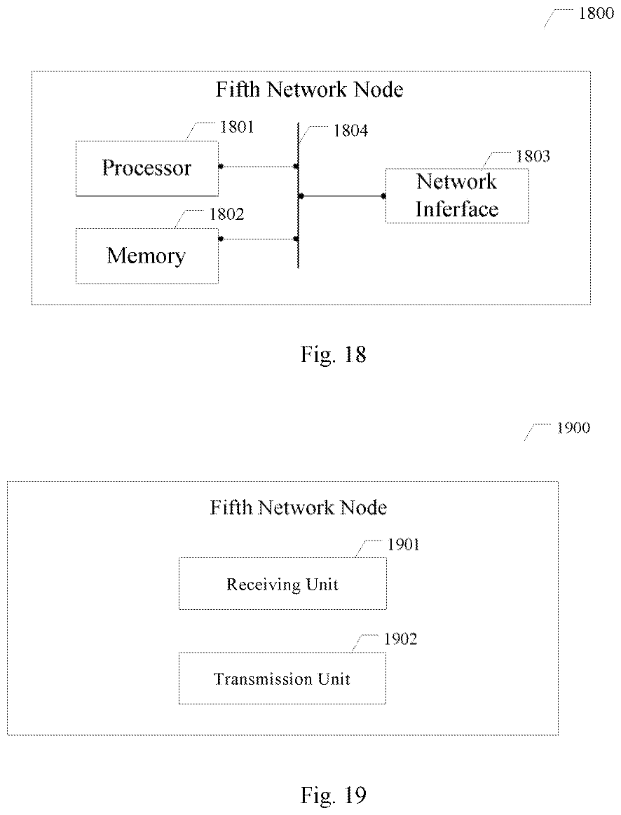

FIG. 18 is a block diagram illustrating a fifth network node 1800 according to some embodiments of the present disclosure. As an example, the fifth network node 1800 may act as the master RAN node 405 as shown in FIG. 4. It should be appreciated that the fifth network node 1800 may be implemented using components other than those illustrated in FIG. 18.

With reference to FIG. 18, the fifth network node 1800 may comprise at least a processor 1801, a memory 1802, a network interface 1803 and a communication medium 1804. The processor 1801, the memory 1802 and the network interface 1803 are communicatively coupled to each other via the communication medium 1804.

The processor 1801, the memory 1802, the network interface 1803 and the communication medium 1804 are structurally similar to the processor 1001, 1201, 1401 or 1601, the memory 1002, 1202, 1402 or 1602, the network interface 1003, 1203, 1403 or 1603 and the communication medium 1004, 1204, 1404 or 1604 respectively, and will not be described herein in detail.

In the example of FIG. 18, the instructions stored in the memory 1802 may include those that, when executed by the processor 1801, cause the fifth network node 1800 to implement the method described with respect to FIG. 9.

FIG. 19 is another block diagram illustrating a fifth network node 1900 according to some embodiments of the present disclosure. As an example, the fifth network node 1900 may act as the master RAN node as shown in FIG. 4. It should be appreciated that the fifth network node 1900 may be implemented using components other than those illustrated in FIG. 19.

With reference to FIG. 19, the fifth network node 1900 may comprise at least a receiving unit 1901 and a transmission unit 1902. The receiving unit 1901 may be adapted to perform at least the operation described in the block 901 of FIG. 9. The transmission unit 1902 may be adapted to perform at least the operation described in the block 902 of FIG. 9.

The units 1101-1104, 1301-1304, 1501-1504, 1701-1703 and 1901-1902 are illustrated as separate units in FIGS. 11, 13, 15, 17 and 19. However, this is merely to indicate that the functionality is separated. The units may be provided as separate elements. However, other arrangements are possible, e.g., some of them may be combined as one unit in each figure. Any combination of the units may be implemented in any combination of software, hardware, and/or firmware in any suitable location. For example, there may be more controllers configured separately, or just one controller for all of the components.

The units shown in FIGS. 11, 13, 15, 17 and 19 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 5-9.

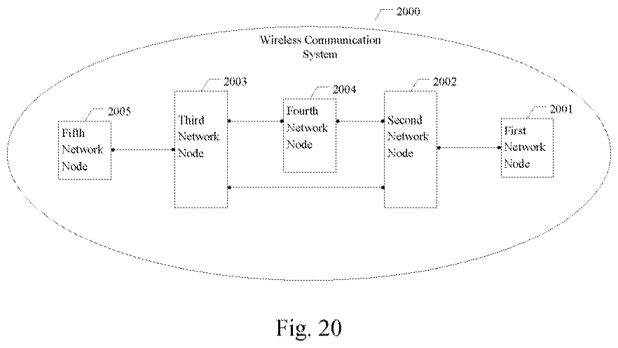

FIG. 20 is a block diagram illustrating a wireless communication system 2000 for status exposure according to some embodiments of the present disclosure. The wireless communication system 2000 comprises at least a first network node 2001, a second network node 2002, a third network node 2003, a fourth network node 2004 and a fifth network node 2005. In one embodiment, the first to fifth network nodes 2001-2005 may act as the first network node 1000 (which functions as an SCS/AS or AF) as depicted in FIG. 10, the second network node 1200 as depicted in FIG. 12, the third network node 1400 as depicted in FIG. 14, the fourth network node 1600 as depicted in FIG. 16 and the fifth network node 1800 as depicted in FIG. 18 respectively. In one embodiment, the second network node 2002 may communicate with at least the first network node 2001, the third network node 2003 and the fourth network node 2004, and the third network node 2003 may communicate with at least the second network node 2002, the fourth network node 2004 and the fifth network node 2005.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1-43. (canceled)

44. A method implemented by a first network node in a wireless communication network, the method comprising:
locating a second network node in the wireless communication network;
transmitting a configuration request for monitoring one or more events comprising secondary radio access technology (RAT) usage to the second network node; and
receiving a report on a secondary RAT usage event from the second network node.

45. The method of claim 44, wherein the secondary RAT usage event includes a secondary RAT usage start event.

46. The method of claim 45, wherein if secondary RAT connectivity is at least one of modified or released, the secondary RAT usage event further includes at least one of a secondary RAT usage modification event or a secondary RAT usage stop event.

47. The method of claim 44, wherein the configuration request comprises an external identity for identifying one or more User Equipment connected to secondary RAT.

48. The method of claim 44, further comprising:
updating a business logic corresponding to the secondary RAT usage based on the report.

49. The method of claim 44, wherein the first network node is one of a Service Capability Server/Application Server (SCS/AS), an Application Function (AF), a Service Capability Exposure Function (SCEF), and a Network Exposure Function (NEF), and wherein the second network node is one of the SCEF, the NEF, a Mobility Management Entity (MME), an Access and Mobility Management Function (AMF), a Home Subscriber Server (HSS), and a Unified Data Management (UDM).

50. The method of claim 44, wherein the configuration request is received by the first network node from a previous network node which locates the first network node.

51. The method of claim 50, wherein the configuration request comprises an external identity or internal identity for identifying one or more User Equipment connected to secondary RAT.

52. A method implemented by a second network node in a wireless communication network, the method comprising:
receiving a configuration request for monitoring one or more events comprising secondary radio access technology (RAT) usage from a previous network node;
transmitting the configuration request to a subsequent network node located by the second network node;
receiving a report on a secondary RAT usage event from the subsequent network node; and
transmitting the report to the previous network node.

53. The method of claim 52, wherein the configuration request comprises an external identity for identifying one or more User Equipment connected to secondary RAT.

54. The method of claim 53, wherein the previous network node is a first network node which locates the second network node, and the subsequent network node is a third network node or a fourth network node.

55. The method of claim 52, wherein the configuration request comprises an internal identity for identifying one or more User Equipment connected to secondary RAT.

56. The method of claim 55, wherein the previous network node is a fourth network node which locates the second network node, and the subsequent network node is a third network node.

57. The method of claim 52, wherein the secondary RAT usage event includes a secondary RAT usage start event.

58. The method of claim 57, wherein in response to the secondary RAT connectivity being at least one of modified or released, the secondary RAT usage event further includes at least one of a secondary RAT usage modification event or a secondary RAT usage stop event.

59. A first network node configured for operation in a wireless communication network, the first network node comprising:
a processor; and
a memory communicatively coupled to the processor and adapted to store instructions which, when executed by the processor, cause the first network node to:
locate a second network node in the wireless communication network;
transmit a configuration request for monitoring one or more events comprising secondary radio access technology (RAT) usage to the second network node; and
receive a report on a secondary RAT usage event from the second network node.

60. A second network node configured for operation in a wireless communication network, the second network node comprising:
a processor; and
a memory communicatively coupled to the processor and adapted to store instructions which, when executed by the processor, cause the second network node to:
receive a configuration request for monitoring one or more events comprising secondary radio access technology (RAT) usage from a previous network node;
transmit the configuration request to a subsequent network node located by the second network node;
receive a report on a secondary RAT usage event from the subsequent network node; and
transmit the report to the previous network node.
